(19) United States
(12) Patent Application Publication
(10) Pub. No.: US 2017/0200946 A1
(43) Pub. Date: Jul. 13, 2017

(54) ALLOY POWDER FOR ELECTRODES, NEGATIVE ELECTRODE FOR NICKEL-METAL HYDRIDE STORAGE BATTERIES USING SAME, AND NICKEL-METAL HYDRIDE STORAGE BATTERY

(71) Applicant: Panasonic Intellectual Property Management Co., Ltd., Osaka (JP)

(72) Inventors: HIDEAKI OHYAMA, Osaka (JP); IKUO KATSUMATA, Osaka (JP); FUMIO KATO, Osaka (JP)

(73) Assignee: Panasonic Intellectual Property Management Co., Ltd., Osaka (JP)

(21) Appl. No.: 15/314,594

(22) PCT Filed: Sep. 10, 2015
(86) PCT No.: PCT/JP2015/004612

§ 371 Date: Nov. 29, 2016

(30) Foreign Application Priority Data
Sep. 30, 2014 (JP) 2014-200319

(51) Int. Cl. H01M 4/38; C22C 19/00; C22C 19/03; H01M 10/34; H01M 4/36

(52) U.S. Cl. CPC H01M 4/383; H01M 10/345; H01M 4/364; C22C 19/03; C22C 19/007; H01M 2004/027

(57) ABSTRACT

Alloy powder for electrodes includes first hydrogen-absorbing alloy particles having a spherical core portion, and non-spherical second hydrogen-absorbing alloy particles. The average particle diameter of the first hydrogen-absorbing alloy is 50 μm or less. The content of the first hydrogen-absorbing alloy is less than 30 vol %.

### TECHNICAL FIELD

The present invention relates to alloy powder for electrodes, a negative electrode for nickel-metal hydride storage batteries using the alloy powder, and a nickel-metal hydride storage battery, and more specifically to improvement of alloy powder for electrodes using a hydrogen-absorbing alloy.

### BACKGROUND ART

In a nickel-metal hydride storage battery, a negative electrode including a hydrogen-absorbing alloy as a negative electrode active material is used. This type of alkaline storage battery has a high power characteristic, and has a high durability (for example, life property and/or storage stability). Therefore, such an alkaline storage battery receives attention as an alternative of a dry battery and as a power source of an electric automobile or the like. A lithium-ion secondary battery is also used for such a purpose. Therefore, in order to emphasize the advantage of the alkaline storage battery, it is desired to further improve battery characteristics such as capacity, power characteristic, and life property.

A hydrogen-absorbing alloy stably exists as a hydride even when the alloy has absorbed hydrogen. This hydride returns to a metal state by desorbing hydrogen. Generally, when a hydride is formed by absorption of hydrogen, the volume thereof becomes larger. In other words, the hydrogen-absorbing alloy expands to become a hydride. Therefore, when the hydrogen-absorbing alloy is used as a negative electrode material of an alkaline storage battery, charge and discharge of the battery causes repetition of the expansion and contraction due to the absorption and desorption of hydrogen, and causes a crystallographic destruction. When the pulverization of the hydrogen-absorbing alloy progresses due to such destruction, the contact area between the hydrogen-absorbing alloy and the electrolytic solution is increased. Therefore, the corrosion of the hydrogen-absorbing alloy by an alkaline aqueous solution progresses, and the hydrogen-absorbing capability of the hydrogen-absorbing alloy decreases. As a result, the characteristic of the battery degrades.

Therefore, by suppressing the volume change and crystallographic destruction phenomenon that are caused by the expansion and contraction of the hydrogen-absorbing alloy, the life property of the alkaline storage battery is improved. In principle, in order to minimize the stress caused by the expansion and contraction of a solid, it is ideal to cause the expansion and contraction in the concentric direction in a sphere. Spherical particles in the hydrogen-absorbing alloy are tried to be produced in order to improve the life property of the alkaline storage battery. As a specific manufacturing method, an atomizing method of preparing alloy particles by spraying inert gas to molten metal of the alloy is known.

According to the atomizing method, fine spherical alloy particles can be prepared. Differently from a casting method and a roll quenching method, a process of performing mechanical grinding is not required when the alloy particles used for a negative electrode for alkaline storage batteries is prepared. However, alloy particles produced by the atomizing method are spherical, so that the contact between particles and the contact between each alloy particle and a current collector are performed at a point, and the contact area decreases. Therefore, the current collectability of these alloy particles is lower than that of non-spherical alloy particles prepared through the grinding process.

In order to address such problems, a method of improving the current collectability by mixing spherical alloy particles and non-spherical alloy particles is examined. For example, in Patent Literature 1, spherical or non-spherical hydrogen-absorbing alloy particles A having a particle diameter of 30 μm or less are mixed with non-spherical hydrogen-absorbing alloy particles B having a particle diameter that is more than 30 μm and 100 μm or less. The content of hydrogen-absorbing alloy particles A in the total volume of the hydrogen-absorbing alloy particles is 30 vol % to 80 vol %, and the remainder is hydrogen-absorbing alloy particles B. Patent Literature 1 proposes such hydrogen-absorbing alloy particles so that the electric conductivity is improved and the filling density is increased.

In Patent Literature 2, spherical hydrogen-absorbing alloy particles are mixed with amorphous hydrogen-absorbing alloy particles, and the surfaces of the amorphous hydrogen-absorbing alloy particles are coated with nickel and/or cobalt. Patent Literature 2 proposes this structure so as to improve the current collectability and reconciles the life property with the discharge characteristic.

### CITATION LIST

### Patent Literature

PTL 1: Unexamined Japanese Patent Publication No. H11-97002

PTL 2: Unexamined Japanese Patent Publication No. 2002-246015

### SUMMARY OF THE INVENTION

The present invention provides alloy powder for electrodes having a life property and rate characteristic that are improved by effectively utilizing the feature of spherical alloy particles, and provides an electrode for nickel-metal hydride storage batteries and a nickel-metal hydride storage battery using the alloy powder.

Alloy powder for electrodes of one aspect of the present invention includes first hydrogen-absorbing alloy particles having a spherical core portion, and non-spherical second hydrogen-absorbing alloy particles. The average particle diameter of the first hydrogen-absorbing alloy is more than 0 μm and 50 μm or less. The content of the first hydrogen-absorbing alloy is more than 0 vol % and less than 30 vol %.

A negative electrode for nickel-metal hydride storage batteries of the one aspect of the present invention includes the alloy powder for electrodes and a current collector electrically connected to the alloy powder for electrodes.

A nickel-metal hydride storage battery of the one aspect of the present invention includes a positive electrode, the negative electrode, and a separator and alkaline electrolytic solution interposed between the positive electrode and negative electrode.

According to the present invention, the rate characteristic of the nickel-metal hydride storage battery can be improved by a sufficient negative electrode activation while a long service life is secured.

### BRIEF DESCRIPTION OF DRAWINGS

FIG. 1A is a longitudinal sectional view schematically showing the structure of a nickel-metal hydride storage battery in accordance with an exemplary embodiment of the present invention.

FIG. 1B is a schematic sectional view of a negative electrode of the nickel-metal hydride storage battery shown in FIG. 1A.

FIG. 2A is a diagram showing a scanning electron micrograph of particles of a first hydrogen-absorbing alloy in accordance with the exemplary embodiment of the present invention.

FIG. 2B is a schematic diagram of FIG. 2A.

FIG. 2C is a diagram showing a scanning electron micrograph of the cross sections of the particles of the first hydrogen-absorbing alloy in accordance with the exemplary embodiment of the present invention.

FIG. 3A is a diagram showing a scanning electron micrograph of particles of a second hydrogen-absorbing alloy in accordance with the exemplary embodiment of the present invention.

FIG. 3B is a schematic diagram of FIG. 3A.

FIG. 4A is a diagram showing a scanning electron micrograph of a particle of another first hydrogen-absorbing alloy in accordance with the exemplary embodiment of the present invention.

FIG. 4B is a schematic diagram of FIG. 4A.

FIG. 4C is a diagram showing a scanning electron micrograph of the cross section of the particle of another first hydrogen-absorbing alloy in accordance with the exemplary embodiment of the present invention.

### DESCRIPTION OF EMBODIMENT(S)

Prior to the descriptions of an exemplary embodiment of the present invention, problems of a conventional technology are briefly described.

As discussed above, employing spherical alloy particles can suppress the expansion and contraction during charge and discharge, and hence can suppress crystallographic destruction. Therefore, employing spherical alloy particles in a negative electrode can improve the life property of the battery. However, the specific surface area of a spherical alloy particle is smaller than that of a non-spherical alloy particle. Furthermore, since the crystallographic destruction hardly occurs, only a small number of newly-formed surfaces are generated by cracking of the alloy. Therefore, the reaction area between the alloy and the electrolytic solution cannot be made sufficiently large, and the activating effect is smaller than that in the case that non-spherical alloy particles are used. In other words, the effect of changing the hydrogen from the molecular state to the atomic state to promote the hydrogen absorption is small. By using such spherical alloy particles in the negative electrode, the discharge characteristic of the battery becomes low, especially the high-rate characteristic indicating the dischargeable capacity when discharge is performed at a large current becomes low.

In the hydrogen-absorbing alloy negative electrode of Patent Literature 1, when the percentage of spherical alloy particles is increased, the discharge characteristic is apt to decrease, especially the high-rate characteristic depending on the activation of the hydrogen-absorbing alloy is apt to decrease.

In the hydrogen-absorbing alloy negative electrode of Patent Literature 2, in order to compensate for the characteristic of spherical alloy particles having a low activation and low current collectability, coating of Ni or Co is formed on the surfaces of amorphous alloy particles. However, a film-like coating cannot secure a sufficient surface area, and the effect of improving the rate characteristic is also insufficient.

The exemplary embodiment of the present invention is described hereinafter with reference to the accompanying drawings if necessary.

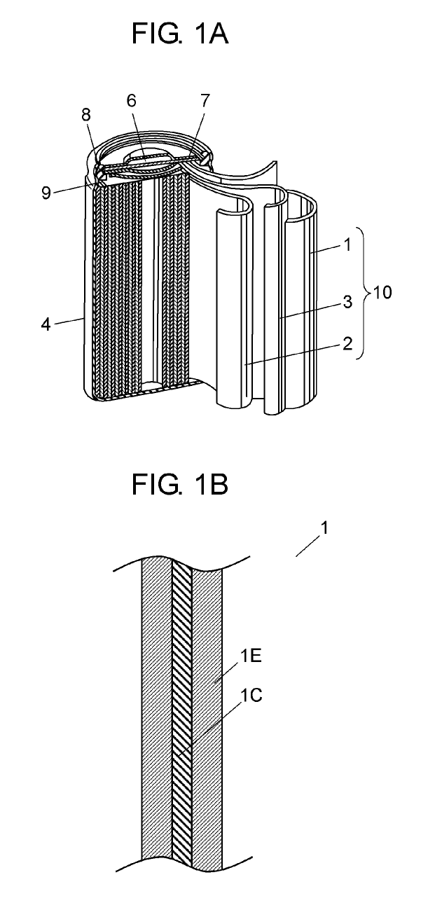

First, the structure of a nickel-metal hydride storage battery of the present exemplary embodiment is described with reference to FIG. 1A. FIG. 1A is a longitudinal sectional view schematically showing the structure of the nickel-metal hydride storage battery in accordance with the present exemplary embodiment. The nickel-metal hydride storage battery includes a bottomed cylindrical battery case 4 serving also as a negative electrode terminal, electrode group 10 accommodated in battery case 4, and an alkaline electrolytic solution (not shown). In electrode group 10, negative electrode 1, positive electrode 2, and separator 3 interposed between them are wound spirally. Seal plate 7 having safety valve 6 is disposed in an opening in battery case 4 via insulating gasket 8. By caulking the opening end of battery case 4 inward so as to grasp seal plate 7, the nickel-metal hydride storage battery is sealed. Seal plate 7 serves also as a positive electrode terminal, and is electrically connected to positive electrode 2 via positive electrode lead 9.

Such a nickel-metal hydride storage battery can be produced as below. First, electrode group 10 is housed in battery case 4. Then, the alkaline electrolytic solution is poured into battery case 4. Then, seal plate 7 is disposed in the opening of battery case 4 via insulating gasket 8. Then, the opening end of battery case 4 is caulked to seal battery case 4. At this time, negative electrode 1 is electrically connected to battery case 4 via a negative-electrode current collector (not shown) disposed between electrode group 10 and the inner bottom of battery case 4. Positive electrode 2 is electrically connected to seal plate 7 via positive electrode lead 9.

Thus, the nickel-metal hydride storage battery includes positive electrode 2, negative electrode 1, separator 3 interposed between positive electrode 2 and negative electrode 1, and an alkaline electrolytic solution. Negative electrode 1 includes alloy powder for electrodes (described later) as a negative electrode active material.

Hereinafter, the components of the nickel-metal hydride storage battery are more specifically described.

(Negative Electrode)

Negative electrode 1 is not particularly limited as long as it includes the alloy powder for electrodes (described later) as the negative electrode active material. As other components, known materials used in the nickel-metal hydride storage battery can be employed.

FIG. 1B is a schematic sectional view of negative electrode 1. Negative electrode 1 may include negative electrode core member (hereinafter referred to as “core member”) 1C as a negative electrode current collector, and negative electrode mixture layer 1E adhering to core member 1C. Negative electrode mixture layer 1E contains a negative electrode active material. Negative electrode 1 can be produced by applying a negative electrode paste including a negative electrode active material to core member 1C to form negative electrode mixture layer 1E.

For core member 1C, a known material can be employed. An example of core member 1C can include a porous or imperforate substrate made of a stainless steel, nickel, or an alloy of nickel. When core member 1C is a porous substrate, the active material may be filled in holes of core member 1C.

The negative electrode paste normally includes a dispersion medium. If necessary, a known component used for the negative electrode—for example, a conductive agent, a binder, or a thickener—may be added to the paste.

Negative electrode 1 can be formed, for example, by applying the negative electrode paste to core member 1C, then removing the dispersion medium through drying, and press-rolling them. As the dispersion medium, a known medium for example, water, an organic medium, or a mixed medium of them can be employed.

The conductive agent is not particularly limited as long as it is an electron-conductive material. Examples of the conductive agent include graphite, carbon black, conductive fiber, metal particles such as copper powder, and an organic conductive material such as a polyphenylene derivative. Examples of the graphite include natural graphite (flake graphite or the like), artificial graphite, and expanded graphite. Examples of the carbon black include acetylene black and ketjen black. Examples of the conductive fiber include carbon fiber and metal fiber. These conductive agents may be used singly or as a combination of two or more. Of these conductive agents, artificial graphite, ketjen black, and carbon fiber are preferable. The amount of the conductive agent is, for example, form 0.01 to 50 part by mass with respect to 100 part by mass of alloy powder for electrodes, and preferably from 0.1 to 30 part by mass, more preferably from 0.1 to 10 part by mass.

The conductive agent may be added to the negative electrode paste, or may be mixed with another component. The conductive agent may be previously applied to the surface of the alloy powder for electrodes. The conductive agent can be applied by a known method. For example, a method can be employed in which the conductive agent is sprinkled on the surface of the alloy powder for electrodes, a dispersion solution containing the conductive agent is applied to the surface and is dried, or the conductive agent is mechanically applied by a mechanochemical method or the like.

The binder is made of a resin material. Examples of the binder include a rubber material such as styrene-butadiene copolymer rubber (SBR), a polyolefin resin; a fluorine resin, an acrylic resin and its Na ion crosslinked polymer. Examples of the polyolefin resin include polyethylene and polypropylene. Examples of the fluorine resin include polytetrafluoroethylene, polyvinylidene fluoride, tetrafluoroethylene-hexafluoropropylene copolymer, and tetrafluoroethylene-perfluoroalkylvinylether copolymer. Examples of the acrylic resin include ethylene-acrylic acid copolymer, ethylene-methacrylic acid copolymer, and ethylene-methyl acrylate copolymer. These binders can be used singly or as a combination of two or more. The amount of the binder is, for example, from 0.01 to 10 part by mass with respect to 100 part by mass of alloy powder for electrodes, and preferably from 0.05 to 5 part by mass.

Examples of the thickener include cellulose derivatives, saponified substances of a polyvinyl alcohol or the like and a polymer having a vinyl acetate unit; and polyalkylene oxides such as polyethylene oxide. Examples of the cellulose derivatives include carboxymethyl cellulose (CMC), modified CMC (including salt such as Na salt), and methyl cellulose. These thickeners can be used singly or as a combination of two or more. The amount of the thickener is, for example, from 0.01 to 10 part by mass with respect to 100 part by mass of alloy powder for electrodes, and preferably from 0.05 to 5 part by mass.

(Positive Electrode)

Positive electrode 2 may include a positive electrode core member (positive electrode current collector), and an active material or active material layer adhering to the positive electrode core member. Positive electrode 2 may be an electrode formed by sintering active material powder.

Positive electrode 2 can be formed by applying, to the positive electrode core member, a positive electrode paste that includes a positive electrode active material. More specifically, in positive electrode 2, a positive electrode mixture adhering to the positive electrode core member can be formed by applying the positive electrode paste to the positive electrode core member, then removing the dispersion medium through drying, and press-rolling them.

For the positive electrode core member, a known material can be employed. An example of the positive electrode core member can include a porous substrate such as a nickel foam and a sintered nickel plate made of nickel or nickel alloy.

As the positive electrode active material, for example, a nickel compound such as nickel hydroxide and nickel oxyhydroxide is employed. Positive electrode 2 is completed by applying or filling a positive electrode paste containing such a positive electrode active material into a positive electrode core member, drying the positive electrode paste, cutting them into a predetermined dimension, and connecting positive electrode lead 9 to the positive electrode core member.

The positive electrode paste normally includes a dispersion medium. If necessary, a known component used for positive electrode 2—for example, a conductive agent, a binder, or a thickener—may be added to the paste. The dispersion medium, the conductive agent, the binder, the thickener, and their amounts can be selected from components or ranges similar to those of the negative electrode paste. As the conductive agent, a conductive cobalt oxide such as cobalt hydroxide and cobalt γ-oxyhydroxide may be employed. The positive electrode paste may include, as an additive, a metal compound (oxide or hydroxide) such as zinc oxide and zinc hydroxide.

(Separator)

For separator 3, a known material used for a nickel-metal hydride storage battery—for example, a microporous film, a non-woven fabric, or a laminated body of them—can be employed. Examples of the material of the microporous film and non-woven fabric can include a polyolefin resin such as polyethylene and polypropylene, a fluorine resin, and a polyamide resin. From the viewpoint of a high degradation resistance against the alkaline electrolytic solution, it is preferable to employ separator 3 made of polyolefin resin.

Preferably, through a hydrophilic treatment, a hydrophilic group is previously introduced to separator 3 made of a material having a high hydrophobicity, such as the polyolefin resin. As an example of the hydrophilic treatment, a corona discharge treatment, a plasma treatment, or a sulfonation treatment can be employed. One of these hydrophilic treatments may be applied to separator 3, or a combination of two or more may be applied. For example, separator 3 to which both of the corona discharge treatment and the sulfonation treatment are applied may be employed. Preferably, at least the sulfonation treatment is previously applied to separator 3. Through the sulfonation treatment, a sulfonic acid group is introduced to separator 3. In other words, separator 3 having undergone the sulfonation treatment includes a sulfonic acid group.

The thickness of separator 3 can be appropriately selected from the range from 10 to 300 μm, for example. The thickness may be in the range from 15 to 200 μm, for example. When separator 3 is made of a microporous film, the thickness of separator 3 is from 10 to 100 μm, for example, and preferably from 10 to 50 μm, more preferably from 15 to 40 μm. When separator 3 has a non-woven fabric structure, the thickness of separator 3 is from 50 to 300 μm, for example, and preferably from 70 to 200 μm, more preferably from 80 to 150 μm.

Preferably, separator 3 has a non-woven fabric structure. As an example of separator 3 having a non-woven fabric structure, a non-woven fabric, or a laminated body of a non-woven fabric and a microporous film can be employed. The mass per unit area of separator 3 having a non-woven fabric structure is from 35 to 70 g/m², for example, and preferably from 40 to 65 g/m², more preferably from 45 to 55 g/m².

(Alkaline Electrolytic Solution)

As the alkaline electrolytic solution, for example, an aqueous solution containing an alkaline compound (alkaline electrolyte) is employed. As an example of the alkaline compound, alkali metal hydroxide such as lithium hydroxide, potassium hydroxide, and sodium hydroxide can be employed. These compounds can be used singly or as a combination of two or more.

From the viewpoint of suppressing the self-decomposition of the positive electrode active material hence suppressing the self-discharge easily, the alkaline electrolyte preferably includes sodium hydroxide. The alkaline electrolyte may include sodium hydroxide and at least one compound selected from the group consisting of potassium hydroxide and lithium hydroxide.

The concentration of sodium hydroxide in the alkaline electrolytic solution is from 5 to 40 mass % for example, and preferably from 9.5 to 35 mass %, more preferably from 9.7 to 33 mass %. When the concentration of sodium hydroxide is in such a range, the self-discharge can be more effectively suppressed.

When the alkaline electrolytic solution includes potassium hydroxide, the ion conductivity of the electrolytic solution is easily increased and the power of the battery is easily increased. The concentration of the potassium hydroxide in the alkaline electrolytic solution can be selected from the range from 0 to 45 mass %, or may be in the range from 0.05 to 41 mass % or from 0.1 to 33 mass %. When the alkaline electrolytic solution includes potassium hydroxide, the concentration of the potassium hydroxide in the alkaline electrolytic solution may be higher than that of the sodium hydroxide. From the viewpoint of more effectively suppressing the self-discharge, the concentration of the potassium hydroxide may be lower than that of the sodium hydroxide.

When the alkaline electrolytic solution includes lithium hydroxide, the oxygen overvoltage is easily increased. When the alkaline electrolytic solution includes lithium hydroxide, from the viewpoint of securing a high ion conductivity of the electrolytic solution, the concentration of the lithium hydroxide in the alkaline electrolytic solution can be appropriately selected from the range from 0 to 5 mass %, for example. The concentration may be in a range from 0.1 to 3 mass %, or from 0.1 to 1 mass %. The specific gravity of the alkaline electrolytic solution is from 1.03 to 1.55, for example, preferably from 1.11 to 1.32.

(Alloy Powder for Electrodes)

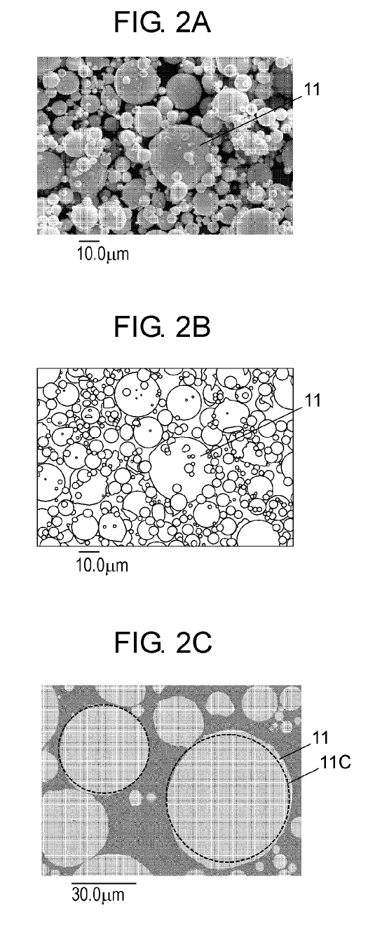

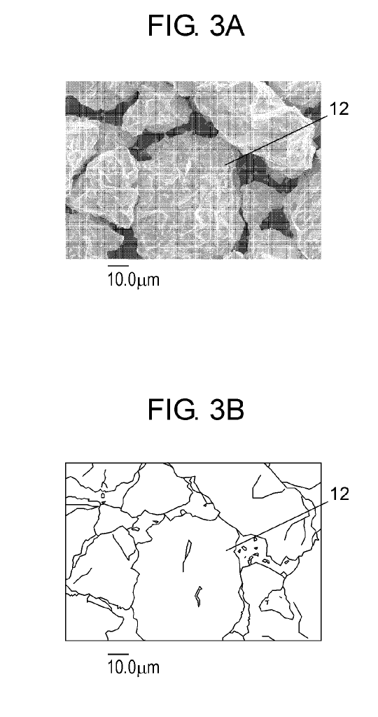

FIG. 2A is a diagram showing a scanning electron micrograph of particles 11 of a first hydrogen-absorbing alloy included in alloy powder for electrodes used for negative electrode 1. FIG. 2B is a schematic diagram of the scanning electron micrograph. FIG. 2C is a diagram showing a scanning electron micrograph of the cross sections of particles 11. FIG. 3A is a diagram showing a scanning electron micrograph of particles 12 of a second hydrogen-absorbing alloy included in alloy powder for electrodes used for negative electrode 1. FIG. 3B is a schematic diagram of the scanning electron micrograph.

Alloy powder for electrodes used for negative electrode 1 is a mixed material of particles 11 of the first hydrogen-absorbing alloy including spherical core portions 11C and non-spherical particles 12 of the second hydrogen-absorbing alloy. The average particle diameter D₁ of the first hydrogen-absorbing alloy is 50 μm or less. The content of the first hydrogen-absorbing alloy in the mixed material is less than 30 vol %.

In other words, the alloy powder for electrodes of the present exemplary embodiment includes spherical particles 11 that hardly undergo a crystallographic destruction caused by the absorption and desorption of hydrogen. Here, the spherical shape includes a similar shape such as a chicken-egg shape. Particle 11 shown in FIG. 2C is formed of substantially-spherical core portion 11C. Therefore, the pulverization percentage as the mixed material is suppressed, and the degradation in the hydrogen-absorbing capability can be suppressed.

Furthermore, since the average particle diameter of particles 11 is relatively small, the surface area of them can be increased. Making the volume percentage of particles 11 lower than 30 vol % allows the activation of the whole mixed material to be improved. Therefore, the service life of the nickel-metal hydride storage battery including the alloy powder for electrodes is extended, and negative electrode 1 can be sufficiently activated to improve the rate characteristic.

From the viewpoint of extending the service life and improving the rate characteristic, the content of the first hydrogen-absorbing alloy is preferably 5 vol % or more and 25 vol % or less. Here, the average particle diameter means a median diameter.

Average particle diameter D₁ of the first hydrogen-absorbing alloy is preferably 20 μm or more and 50 μm or less, more preferably 25 μm or more and 40 μm or less. When average particle diameter D₁ is in such ranges, the activation is easily caused while the pulverization of the first hydrogen-absorbing alloy is suppressed.

Average particle diameter D₂ of the second hydrogen-absorbing alloy is preferably 15 μm or more and 60 μm or less, more preferably 30 μm or more and 50 μm or less. When average particle diameter D₂ is in such ranges, the activation is easily caused while the pulverization of the second hydrogen-absorbing alloy particles is suppressed.

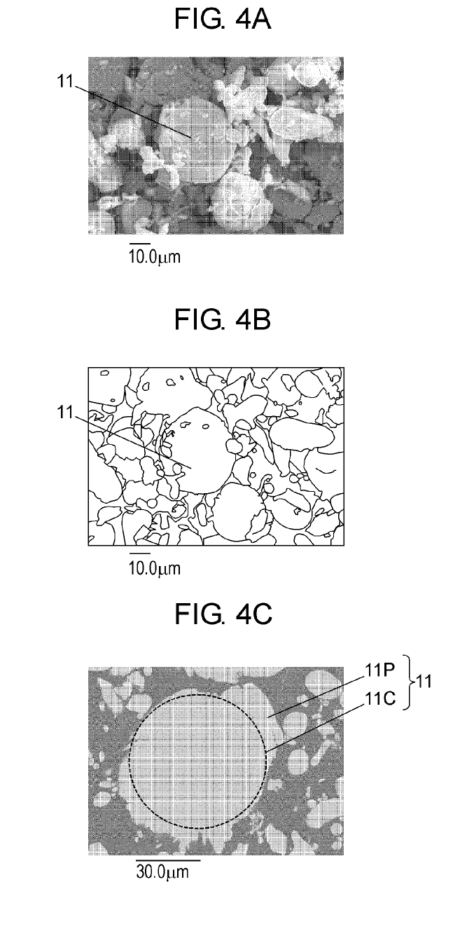

FIG. 4A is a diagram showing a scanning electron micrograph of particle 11 of another first hydrogen-absorbing alloy. FIG. 4B is a schematic diagram of the scanning electron micrograph. FIG. 4C is a diagram showing a scanning electron micrograph of the cross section of particle 11.

From the viewpoint of the rate characteristic, the activation of the hydrogen-absorbing alloy is especially important. The activation of the hydrogen-absorbing alloy is associated with the surface shapes, surface compositions, and specific surface areas of the particles of the hydrogen-absorbing alloy. Therefore, as shown in FIG. 4A to FIG. 4C, preferably, particle 11 has projecting portion 11P whose height from the surface of core portion 11C is equal to or more than 10% of the diameter of core portion 11C. Projecting portion 11P allows a nano-sized catalyst action on the surface of particle 11 to be promoted, and can improve the rate characteristic. The height of projecting portion 11P is substantially lower than 100% of the diameter of core portion 11C.

Specific surface area S₁ of the first hydrogen-absorbing alloy is preferably 0.01 g/m² or more and 1.0 g/m² or less, for example. Thus, optimizing the specific surface area of the first hydrogen-absorbing alloy allows the activation to be promoted while the pulverization due to the expansion and contraction is suppressed. The specific surface area of the first hydrogen-absorbing alloy having spherical core portions does not exceed 1.0 g/m². While, it is known that the specific surface area of the second hydrogen-absorbing alloy greatly exceeds 1.0 g/m². Therefore, the first hydrogen-absorbing alloy is differentiated from the second hydrogen-absorbing alloy using 1.0 g/m² as the threshold.

In order to form projecting portions 11P on the surface of the first hydrogen-absorbing alloy and adjust the specific surface area, when a hydrogen-absorbing alloy is produced by an atomizing method for example, mixed gas of argon and nitrogen is sprayed to the hydrogen-absorbing alloy to cool it. Thus, nitride is formed on the surface of the hydrogen-absorbing alloy. Specifically, projecting portions 11P are formed of the nitride existing on the surface of the hydrogen-absorbing alloy, and the specific surface area can be adjusted. The amount of the nitride formed on the surface of the hydrogen-absorbing alloy can be changed by changing the mixing ratio of nitrogen gas and argon gas.

This nitride is considered to suppress excessive corrosion degradation of the first hydrogen-absorbing alloy in a battery, and hence the degradation of the first hydrogen-absorbing alloy can be suppressed. For example, it is preferable that nitrogen content Ni is more than 0 wt % and 0.2 wt % or less.

Furthermore, preferably, by heating the hydrogen-absorbing alloy immersed in an alkaline aqueous solution before assembling a battery, an atomic or nano-sized N₁ cluster (magnetic substance) is formed on the surface of the hydrogen-absorbing alloy, for example. This magnetic substance takes a catalyst action to the absorption and desorption of hydrogen. When the hydrogen-absorbing alloy with the magnetic substance is used as an electrode active material of an alkaline storage battery, increasing the amount of magnetic substance increases the diffusion speed of hydrogen on the surface of the hydrogen-absorbing alloy, and can improve the discharge characteristic.

The content of the magnetic substance included in the alloy powder for electrodes can be measured using a vibration-sample magnetic measuring device, for example. Specifically, saturation magnetization of the alloy powder for electrodes in a magnetic field of 10 kOe is determined, and the metallic nickel amount (magnetic substance Ni amount) corresponding to the saturation magnetization is determined. The content of the magnetic substance is calculated on the basis of the magnetic substance Ni amount.

In each of the first and second hydrogen-absorbing alloys of the present exemplary embodiment, preferably, the content (VSM value) of the magnetic substance is more than 0 wt % and less than 3 wt %, for example. When the content is in such a range, the battery reaction can be more efficiently performed by using the alloy powder for electrodes as an electrode active material in the alkaline storage battery. Degradation in battery capacity can be suppressed by suppressing the elution of a constituent element of the hydrogen-absorbing alloy.

The first hydrogen-absorbing alloy and/or second hydrogen-absorbing alloy, for example, may have any one of crystal lattices of AB₂ type, AB₃ type, AB₅ type, and A₂B₇ type. Especially, hydrogen-absorbing alloys having crystal structures of AB₂ type and AB₅ type are preferable. Here, the first and second hydrogen-absorbing alloys may have different crystal structures, and have different compositions.

Preferably, the composition of the first hydrogen-absorbing alloy and/or second hydrogen-absorbing alloy includes element L¹, element M¹, and Ni. The composition may include element E¹ as an optional component. Element L¹ is at least one element selected from the group consisting of the elements in group 3 and the elements in group 4 on the periodic table. Element M¹ is an alkaline-earth metal element.

Of elements L¹, the elements in group 3 on the periodic table include Sc, Y, lanthanoid elements, and actinoid elements. The lanthanoid elements include La, Ce, Pr, Nd, Pm, Sm, Eu, Gd, Tb, Dy, Ho, Er, Tm, Yb, and Lu. The actinoid elements include Ac, Th, Pa, and Np, for example. Of elements L¹, the elements in group 4 on the periodic table include Ti, Zr, and Hf.

Examples of the alkaline-earth metal element as element M¹ include Mg, Ca, Sr, and Ba. Element M¹ may include one of these alkaline-earth metal elements, or may include a combination of two or more thereof. Thanks to such elements M¹, a hydride of ionic bond is easily produced, the hydrogen-absorbing capability is improved, and hence the capacity is easily increased. Of elements M¹, Mg and/or Ca is preferable.

Preferably, the hydrogen-absorbing alloy includes Ni as an essential component.

Element E¹ is at least one element selected from the group consisting of the transition metal elements (except Ni) in groups 5 to 11 on the periodic table, the elements in group 12, the elements in group 13 periods 2 to 5, the elements in group 14 periods 3 to 5, and P. Examples of transition metal elements include V, Nb, Ta, Cr, Mo, W, Mn, Fe, Co, Pd, Cu, and Ag. Examples of the elements in group 12 include Zn. Examples of the elements in group 13 include B, Al, Ga, and In. Examples of the elements in group 14 include Si, Ge, and Sn.

(Manufacturing Method of Alloy Powder for Electrodes)

Alloy powder for electrodes can be prepared by mixing the first hydrogen-absorbing alloy particles and the second hydrogen-absorbing alloy particles.

The first hydrogen-absorbing alloy particles and second hydrogen-absorbing alloy particles can be prepared through the following processes:

(1) process A₁ of producing an alloy from the simple substances (e.g. elemental metals) of the constituent elements of the first hydrogen-absorbing alloy, and process A₂ of producing an alloy from the simple substances of the constituent elements of the second hydrogen-absorbing alloy;

(2) process B of granulating the second hydrogen-absorbing alloy obtained in process A₂; and

(3) process C of activating the granulated substances obtained in process A₁ and process B.

(1) Process A₁ and Process A₂ (Alloying Process)

In process A₁ of producing the first hydrogen-absorbing alloy, for example, an alloy can be produced from the simple substances of the constituent elements using a known alloying method. As such an alloying method, a rapid solidification method can be employed, for example. Specific examples of the rapid solidification method include a roll spinning method, a melt drag method, a direct casting and rolling method, a rotating liquid spinning method, a spray forming method, a gas atomizing method, a wet spraying method, a splat method, a rapid-solidification thin strip grinding method, a gas atomization splat method, a melt extraction method, and a rotating electrode method. These methods can be used singly or as a combination of two or more.

In process A₁, the following method may be employed. The simple substances of the constituent elements are mixed, the obtained mixture is heated to be molten, and then the constituent elements are alloyed. As such an alloying method, the rapid solidification method (specifically, gas atomizing method) is appropriate, for example.

In process A₁, in mixing the simple substances of the constituent elements, the molar ratio and mass ratio between constituent elements are adjusted so that the hydrogen-absorbing alloy has a desired composition. Molten metal obtained through melting by a high-frequency induction heating furnace in an inert gas atmosphere is dropped from the bottom of a crucible, and high-pressure cooling gas is sprayed to the molten metal, thereby producing spherical alloy particles. As the cooling gas, argon gas, nitrogen gas, or a mixed gas of argon gas and nitrogen gas is employed, for example.

The obtained alloy particles may be heated if necessary. By the heating treatment, the dispersibility of the constituent elements in the hydrogen-absorbing alloy can be adjusted. As a result, the elution and/or segregation of the constituent elements can be more effectively suppressed, and the hydrogen-absorbing alloy is easily activated. The heating condition is not particularly limited. For example, the obtained alloy particles can be heated at a temperature from 700 to 1200° C. under the atmosphere of inert gas such as argon.

In process A₂, for example, an alloy can be produced from the simple substances of the constituent elements using a known alloying method. As such an alloying method, a plasma arc melting method, a high frequency melting method (metal mold casting method), a mechanical alloying method (machine alloy method), a mechanical milling method can be employed, for example. These methods can be used singly or as a combination of two or more.

In process A₂, the simple substances of the constituent elements are mixed, and the obtained mixture can be alloyed by the above-mentioned methods. The constituent elements may be alloyed by heating and melting the mixture. As such an alloying method, the plasma arc melting method and a high frequency melting method (metal mold casting method) are appropriate, for example.

In process A₂, in mixing the simple substances of the constituent elements, the molar ratio and mass ratio between constituent elements are adjusted so that the hydrogen-absorbing alloy has a desired composition.

The molten alloy is solidified prior to the granulation in process B. The molten alloy can be solidified by supplying it to a mold or the like if necessary, and cooling it in the mold. From the viewpoint of improving the dispersibility of the constituent elements in the alloy, the supply speed or the like may be appropriately adjusted.

The obtained solidified alloy (ingot) may be heated if necessary. By the heating treatment, the dispersibility of the constituent elements in the hydrogen-absorbing alloy can be adjusted. As a result, the elution and/or segregation of the constituent elements can be more effectively suppressed, and the hydrogen-absorbing alloy is easily activated. The heating condition is not particularly limited. For example, the obtained solidified alloy can be heated at a temperature from 700 to 1200° C. under the atmosphere of inert gas such as argon.

(2) Process B (Granulating Process)

In process B, the alloy (specifically, ingot) obtained in process A₂ is granulated. The alloy can be granulated by wet grinding or dry grinding. These methods may be combined together. Specifically, the ingot can be ground using a ball mill or the like. In the wet grinding, the ingot is ground using a liquid medium such as water. Obtained particles may be classified if necessary.

(3) Process C (Activating Process)

In process C, the ground product obtained in process A₁ and process B is activated. At this time, the alloy particles are brought into contact with an alkaline aqueous solution. The method of bringing the raw powder into contact with the alkaline aqueous solution is not particularly limited. The raw powder can be brought into contact with the alkaline aqueous solution, for example, by immersing the raw powder in the alkaline aqueous solution, by adding the raw powder to the alkaline aqueous solution and stirring them, or by spraying the alkaline aqueous solution to the raw powder. The raw powder may be activated in the heating state if necessary.

An example of the alkaline aqueous solution used for activation can include an aqueous solution containing, as alkali, an alkali metal hydroxide such as potassium hydroxide, sodium hydroxide, and lithium hydroxide. Among them, preferably, sodium hydroxide and/or potassium hydroxide are used.

From the viewpoint of improving the efficiency of activation, productivity, and process reproducibility, the alkali concentration in the alkaline aqueous solution is from 5 to 50 mass % for example, preferably from 10 to 45 mass %.

After the activation treatment by the alkaline aqueous solution, the obtained alloy particles may be washed with water. In order to reduce the remaining of impurities on the surface of the alloy particles, preferably, the wash with water is finished after the pH of the water having been used for the wash becomes 9 or less. The alloy particles after the activation treatment are normally dried.

The particle size distribution of the alloy particles can be measured by a dynamic light scattering method (laser diffraction method), an electric detection zone method, a sedimentation method, or an image analysis method, for example. Especially, the image analysis method (flow-type image analysis particle diameter/shape measuring device) is suitable because this method allows information of particle shapes to be easily acquired. In the image analysis method, particles to be measured are dispersed uniformly using a dispersion medium, and are made to pass through a flow cell. Then, the flow cell is irradiated with light from a light source, a projection image when the particles pass through the cell is shot with a high-sensitive CCD camera. The particle image is converted into digital data, and is fed to a personal computer (PC) for analysis. Then, circle-equivalent diameters and shape information of the particles are determined.

The alloy powder for electrodes is required to be a mixed material of particles 11 of the first hydrogen-absorbing alloy and particles 12 of the second hydrogen-absorbing alloy, and may be in a state in which particles 11 adhere to the surfaces of particles 12. It is more preferable from the viewpoint of the high density filling that particles 11 adhere to the surfaces of particles 12. In the mixed material in such a state, the ratio (D₁/D₂) of average particle diameter D₁ of the first hydrogen-absorbing alloy with respect to average particle diameter D₂ of the second hydrogen-absorbing alloy is, for example, 0.3 or more and 3.4 or less, preferably more than 0.3 and 2 or less, more preferably 0.3 or more and 0.9 or less.

Hereinafter, the advantages of the present exemplary embodiment are specifically described on the basis of examples and comparative examples. The present invention is not limited to the following examples.

(Sample A1)

(1) Production of First Hydrogen-Absorbing Alloy Particles

The simple substances of La, Ce, Mg, Ni, Co, Mn, and Al are mixed at percentages at which the composition of the hydrogen-absorbing alloy is La_{0.66}Ce_{0.27}Mg_{0.07}Ni_{1.00}Co_{0.30}Mn_{0.10}Al_{0.30}. This mixture is melted by the high-frequency induction heating furnace in an inert gas atmosphere, thereby producing molten metal. The molten metal is dropped from the bottom of a crucible at a speed of 2 m/min, high-pressure argon gas is sprayed to the dropped molten metal, and spherical alloy particles are prepared. FIG. 2A shows the result obtained when the shapes of the alloy particles prepared in this manner are observed with a scanning electron microscope. The spherical alloy particles are heated at 900° C. for 10 hours in an argon atmosphere, and the particles after the heat treatment are passed through a sieve of a mesh size of 75 μm in a dry state. Thus, raw powder including the first hydrogen-absorbing alloy of an average particle diameter of 30 μm is prepared.

This raw powder is mixed with an alkaline aqueous solution containing sodium hydroxide at a concentration of 40 mass %, and stirred at 100° C. for 50 minutes (alkaline treatment). The obtained powder is collected, washed with hot water, dehydrated, and then dried. The washing is continued until the pH of the hot water after use becomes 9 or less. Thus, first hydrogen-absorbing alloy particles from which impurities have been removed are obtained. Average particle diameter D₁ of the first hydrogen-absorbing alloy of is 30 μm.

(2) Production of Second Hydrogen-Absorbing Alloy Particles

The simple substances of La, Ce, Mg, Ni, Co, Mn, and Al are mixed at the same percentages as those of the first hydrogen-absorbing alloy, and are melted by a high-frequency melting furnace. The molten metal is poured (supplied) into a mold at a speed of 2 m/min, and an ingot is produced. The obtained ingot is heated at 1060° C. for 10 hours in an argon atmosphere. The ingot after the heat treatment is ground into coarse particles. The obtained coarse particles are ground in the presence of water using a wet ball mill, and are passed through a sieve of a mesh size of 90 μm in a wet state. Thus, raw powder including the hydrogen-absorbing alloy of an average particle diameter of 45 μm is prepared.

Then, second hydrogen-absorbing alloy particles from which impurities have been removed are obtained by applying the alkaline treatment, the washing, and the drying to the raw powder, similarly to the first hydrogen-absorbing alloy.

(3) Production of Negative Electrode

Alloy powder for electrodes is prepared by uniformly mixing the first hydrogen-absorbing alloy particles obtained in process (1) and the second hydrogen-absorbing alloy particles obtained in process (2) at a volume ratio of 20:80.

To 100 part by mass of alloy powder for electrodes, 0.15 part by mass of CMC (degree of etherification is 0.7, and degree of polymerization is 1600), 0.3 part by mass of acetylene black, and 0.7 part by mass of SBR are added, and further water is added. They are then kneaded to prepare a negative electrode paste. The obtained electrode paste is applied to both surfaces of a negative electrode core member that is made of a perforated iron plated with nickel (thickness of 60 μm, hole diameter of 1 mm, and open area percentage of 42%). The applied paste is dried to produce a paste coating. The paste coating is pressed together with the negative electrode core member by rollers. A negative electrode sheet produced in that manner is cut to produce a negative electrode of a thickness of 0.4 mm, a width of 35 mm, and a capacity of 2200 mAh. At one end of the negative electrode in its longitudinal direction, a negative electrode mixture is partially removed to form an exposed portion of the negative electrode core member.

(4) Production of Positive Electrode

A positive electrode sheet is produced by filling a positive electrode mixture to a positive electrode core member made of a porous sintered substrate. The positive electrode mixture is obtained by employing, as a positive electrode active material, about 90 part by mass of Ni(OH)₂, adding about 6 part by mass of Zn(OH)₂ as an additive, and adding about 4 part by mass of Co(OH)₂ as a conductive material. The positive electrode sheet produced in that manner is cut into a predetermined dimension, a sintered positive electrode of a capacity of 1500 mAh is prepared. At one end of the positive electrode core member in its longitudinal direction, a positive electrode mixture is not filled and an exposed portion of the positive electrode core member is formed.

(5) Production of Nickel-Metal Hydride Storage Battery

A nickel-metal hydride storage battery of 4/5A size with a nominal capacity of 1500 mAh shown in FIG. 1A is produced using the negative electrode and positive electrode produced in processes (4) and (5). Specifically, the positive electrode and negative electrode are wound via the separator to produce a cylindrical electrode group. In the electrode group, the exposed portion of the positive electrode core member having no positive electrode mixture thereon and the exposed portion of the negative electrode core member having no negative electrode mixture thereon are exposed on the opposite end surfaces. As the separator, non-woven fabric (thickness of 100 μm, and mass per unit area of 50 g/cm²) made of sulfonated polypropylene is employed.

A positive electrode current collector is welded to the end surface of the electrode group on which the positive electrode core member is exposed. A negative electrode current collector is welded to the end surface of the electrode group on which the negative electrode core member is exposed. A seal plate is electrically connected to the positive electrode current collector via a positive electrode lead. Then, the electrode group is stored in a battery case formed of a bottomed cylindrical can so that the negative electrode current collector is disposed on the downside. The negative electrode lead connected to the negative electrode current collector is then welded to the bottom of the battery case. The electrolytic solution is poured into the battery case, and then the opening in the battery case is sealed with the seal plate having an insulating gasket on its periphery. Thus, a nickel-metal hydride storage battery (sample A1) is completed.

As the electrolytic solution, an alkaline aqueous solution (specific gravity: 1.23) containing sodium hydroxide by 31 mass %, potassium hydroxide by 1 mass %, and lithium hydroxide by 0.5 mass % is employed.

(Samples A2-A9 and B1-B4)

In producing first hydrogen-absorbing alloy particles, when molten metal is dropped from the bottom of the crucible, high-pressure mixed gas of argon gas and nitrogen gas is sprayed to the dropped molten metal, and spherical alloy particles are prepared. The mixing volume percentage of argon gas is 99.98 vol %, and that of nitrogen gas is 0.02%. In samples A2-A9 and B1-B4, the content (vol %) of the first hydrogen-absorbing alloy in the alloy powder for electrodes is changed as shown in Table 1. Similarly to sample A1 except this condition, nickel-metal hydride storage batteries of samples A2-A9 and B1-B4 are produced. FIG. 4A to FIG. 4C show the first hydrogen-absorbing alloy of sample A2.

(Samples A10-A15 and B5)

In producing first hydrogen-absorbing alloy particles, the nozzle diameter set when molten metal is dropped from the bottom of the crucible is changed and hence the size of the droplet is changed. Thus, the average particle diameter of the first hydrogen-absorbing alloy is changed as shown in Table 1. Similarly to sample A2 except this process, nickel-metal hydride storage batteries of samples A10-A15 and B5 are produced.

(Samples A16-A23)

In producing second hydrogen-absorbing alloy particles, the condition (for example, grinding time) when coarse particles are ground in the presence of water using a wet ball mill is changed, and the mesh size of a sieve used in a wet state is changed. Thus, the average particle diameter of the second hydrogen-absorbing alloy is changed as shown in Table 1. Similarly to sample A2 except this process, nickel-metal hydride storage batteries of samples A16-A23 are produced.

(Samples A24-A27)

In producing first hydrogen-absorbing alloy particles, the ratio between argon gas and nitrogen gas in the high-pressure mixed gas sprayed when molten metal is dropped from the bottom of the crucible are changed. Specifically, the volume percentage of nitrogen gas is 0.01 vol % in sample A24, 0.03 vol % in sample A25, 0.04 vol % in sample A26, and 0.05 vol % in sample A27. As a result, the height of projecting portions on the first hydrogen-absorbing alloy particles, the specific surface area of the first hydrogen-absorbing alloy particles, and nitrogen content N₁ are changed as shown in Table 1. Similarly to sample A2 except this process, nickel-metal hydride storage batteries of samples A24-A27 are produced.

(Samples A28-A30)

In producing second hydrogen-absorbing alloy particles, the duration of the alkaline treatment is changed. Specifically, the duration is 100 minutes in sample A28, 150 minutes in sample A29, and 180 minutes in sample A30. As a result, the content of the Ni magnetic substance in the second hydrogen-absorbing alloy is changed as shown in Table 1. Similarly to sample A2 except this process, nickel-metal hydride storage batteries of samples A28-A30 are produced.

(Samples A31-A33)

In producing first hydrogen-absorbing alloy particles, the duration of the alkaline treatment is changed. Specifically, the duration is 80 minutes in sample A31, 100 minutes in sample A32, and 130 minutes in sample A33. As a result, the content of the Ni magnetic substance in the first hydrogen-absorbing alloy is changed as shown in Table 1. Similarly to sample A2 except this process, nickel-metal hydride storage batteries of samples A31-A33 are produced.

(6) Evaluation

The nickel-metal hydride storage batteries of the samples produced in those manners are evaluated as below.

(a) High-Temperature Life Property

The nickel-metal hydride storage battery of each sample is charged at 10-hour rate (150 mA) in an environment of 40° C. for 15 hours, and is discharged at 5-hour rate (300 mA) until the battery voltage falls to 1.0 V. This charge/discharge cycle is repeated 100 times, and the ratio of the discharge capacity at the 100th cycle with respect to that at the second cycle is determined as a capacity retention ratio on percentage.

(b) Low-Temperature Discharge Characteristic

The nickel-metal hydride storage battery of each sample is charged at 20° C. with a current of 0.75 A until the capacity becomes 120% of the theoretical capacity, and is discharged at 20° C. with a current of 0.3 A until the battery voltage falls to 1.0 V. The discharge capacity at this time is measured.

Furthermore, the same nickel-metal hydride storage battery is charged at 20° C. with a current of 0.75 A until the capacity becomes 120% of the theoretical capacity, and is discharged at −10° C. with a current of 1.5 A until the battery voltage falls to 1.0 V. The discharge capacity (low-temperature discharge capacity) at this time is measured.

The low-temperature discharge capacity is divided by the discharge capacity at 20° C. to be expressed on percentage. Thus, a low-temperature discharge rate is obtained. This value is used as an indicator of the low-temperature discharge characteristic.

(c) Rate Characteristic

The nickel-metal hydride storage battery of each sample is charged and discharged at 20° C. similarly to the case of the low-temperature discharge characteristic, and the discharge capacity at 0.3 A is measured.

Furthermore, the same nickel-metal hydride storage battery is charged at 20° C. at a current value of 0.75 A until the capacity becomes 120% of the theoretical capacity, and is discharged at 20° C. with a current of 3.0 A until the battery voltage falls to 1.0 V. The discharge capacity (2It discharge capacity) at this time is measured.

The 2It discharge capacity is divided by the discharge capacity at 0.3 A to be expressed on percentage. Thus, a high-rate discharge rate is obtained. This value is used as an indicator of the rate characteristic.

The results of the above-mentioned evaluation are shown in Table 2.

TABLE 1

| | | | | | | | Second hydrogen- | |
|---|---|---|---|---|---|---|---|---|
| | First hydrogen-absorbing alloy | | | | | | absorbing alloy | |
| | Average | | Projecting | | | Content of | Average | Content of |
| | particle | | portion | Specific | | Ni magnetic | particle | Ni magnetic |
| | diameter | Content | (% vs. | surface | N content | substance | diameter | substance |
| | D1 (μm) | (vol %) | diameter) | area (g/m²) | (wt %) | (wt %) | D2 (μm) | (wt %) |
| A1 | 30 | 20% | 0 | 0.010 | 0.02 | 1.48 | 45 | 0.98 |
| A2 | 30 | 20% | 10 | 0.040 | 0.08 | 1.49 | 45 | 1.02 |
| A3 | 30 | 1% | 10 | 0.040 | 0.08 | 1.51 | 45 | 0.99 |
| A4 | 30 | 5% | 10 | 0.040 | 0.08 | 1.50 | 45 | 1.00 |
| A5 | 30 | 10% | 10 | 0.040 | 0.08 | 1.47 | 45 | 1.01 |
| A6 | 30 | 15% | 10 | 0.040 | 0.08 | 1.51 | 45 | 1.03 |
| A7 | 30 | 23% | 10 | 0.040 | 0.08 | 1.52 | 45 | 1.00 |
| A8 | 30 | 25% | 10 | 0.040 | 0.08 | 1.48 | 45 | 1.01 |
| A9 | 30 | 29% | 10 | 0.040 | 0.08 | 1.49 | 45 | 1.01 |
| B1 | 30 | 30% | 10 | 0.040 | 0.08 | 1.50 | 45 | 0.97 |
| B2 | 30 | 50% | 10 | 0.040 | 0.08 | 1.51 | 45 | 0.98 |
| B3 | 30 | 80% | 10 | 0.040 | 0.08 | 1.54 | 45 | 0.99 |
| B4 | 30 | 100% | 10 | 0.040 | 0.08 | 1.52 | 45 | 1.00 |
| A10 | 18 | 20% | 10 | 0.067 | 0.08 | 1.50 | 45 | 1.01 |
| A11 | 20 | 20% | 10 | 0.060 | 0.08 | 1.50 | 45 | 1.00 |
| A12 | 25 | 20% | 10 | 0.048 | 0.08 | 1.48 | 45 | 1.00 |
| A13 | 40 | 20% | 10 | 0.030 | 0.08 | 1.47 | 45 | 1.02 |
| A14 | 45 | 20% | 10 | 0.027 | 0.08 | 1.52 | 45 | 1.04 |
| A15 | 50 | 20% | 10 | 0.024 | 0.08 | 1.50 | 45 | 1.00 |
| B5 | 55 | 20% | 10 | 0.022 | 0.08 | 1.48 | 45 | 0.98 |
| A16 | 30 | 20% | 10 | 0.040 | 0.08 | 1.50 | 12 | 0.97 |
| A17 | 30 | 20% | 10 | 0.040 | 0.08 | 1.50 | 15 | 1.00 |
| A18 | 30 | 20% | 10 | 0.040 | 0.08 | 1.52 | 30 | 0.99 |
| A19 | 30 | 20% | 10 | 0.040 | 0.08 | 1.50 | 40 | 1.00 |
| A20 | 30 | 20% | 10 | 0.040 | 0.08 | 1.53 | 50 | 1.01 |
| A21 | 30 | 20% | 10 | 0.040 | 0.08 | 1.50 | 55 | 1.00 |
| A22 | 30 | 20% | 10 | 0.040 | 0.08 | 1.52 | 60 | 1.05 |
| A23 | 30 | 20% | 10 | 0.040 | 0.08 | 1.50 | 65 | 0.95 |
| A24 | 30 | 20% | 8 | 0.030 | 0.05 | 1.51 | 45 | 1.00 |
| A25 | 30 | 20% | 13 | 0.080 | 0.10 | 1.47 | 45 | 1.00 |
| A26 | 30 | 20% | 18 | 0.100 | 0.20 | 1.50 | 45 | 1.01 |
| A27 | 30 | 20% | 23 | 0.130 | 0.25 | 1.49 | 45 | 1.00 |
| A28 | 30 | 20% | 10 | 0.040 | 0.08 | 1.50 | 45 | 2.00 |
| A29 | 30 | 20% | 10 | 0.040 | 0.08 | 1.51 | 45 | 2.80 |
| A30 | 30 | 20% | 10 | 0.040 | 0.08 | 1.50 | 45 | 3.40 |
| A31 | 30 | 20% | 10 | 0.040 | 0.08 | 2.10 | 45 | 1.00 |
| A32 | 30 | 20% | 10 | 0.040 | 0.08 | 2.80 | 45 | 1.00 |
| A33 | 30 | 20% | 10 | 0.040 | 0.08 | 3.60 | 45 | 1.00 |

TABLE 2

| | High-temperature | Low-temperature | High-rate |
|---|---|---|---|
| | life property | discharge | discharge |
| | (%) | rate(%) | rate(%) |
| A1 | 79.5 | 55 | 83.0 |
| A2 | 79.0 | 63 | 92.0 |
| A3 | 77.2 | 63 | 92.0 |
| A4 | 78.3 | 63 | 92.5 |
| A5 | 79.5 | 61 | 89.3 |
| A6 | 79.8 | 62 | 90.0 |
| A7 | 80.1 | 58 | 88.0 |
| A8 | 80.5 | 59 | 88.7 |
| A9 | 78.6 | 48 | 75.0 |
| B1 | 76.5 | 23 | 72.0 |
| B2 | 75.0 | 25 | 68.0 |
| B3 | 73.0 | 27 | 55.0 |
| B4 | 69.8 | 10 | 48.0 |
| A10 | 77.2 | 71 | 93.0 |
| A11 | 78.0 | 68 | 91.0 |
| A12 | 78.5 | 66 | 87.0 |
| A13 | 79.3 | 63 | 80.0 |
| A14 | 79.5 | 61 | 78.0 |
| A15 | 79.8 | 59 | 75.0 |
| B5 | 68.0 | 35 | 28.0 |
| A16 | 78.3 | 75 | 92.5 |
| A17 | 79.0 | 68 | 89.3 |
| A18 | 79.8 | 62 | 88.4 |
| A19 | 80.1 | 58 | 87.2 |
| A20 | 80.5 | 52 | 85.2 |
| A21 | 80.7 | 48 | 75.0 |
| A22 | 78.5 | 43 | 72.0 |
| A23 | 77.5 | 38 | 65.0 |
| A24 | 78.8 | 58 | 74.5 |
| A25 | 79.5 | 66 | 83.0 |
| A26 | 79.4 | 69 | 88.0 |
| A27 | 75.0 | 60 | 80.0 |
| A28 | 78.9 | 64 | 92.3 |
| A29 | 78.6 | 65 | 93.6 |
| A30 | 77.0 | 60 | 90.8 |
| A31 | 78.8 | 64 | 92.8 |
| A32 | 78.2 | 66 | 93.5 |
| A33 | 77.0 | 56 | 90.4 |

First, according to the evaluation results of samples A2-A9 and samples B1-B4, it is understood that the high-temperature life property is improved as the volume percentage of the first hydrogen-absorbing alloy particles increases from 1% (sample A3) to 25% (sample A8). However, the dependence of the advantage on the volume percentage is not so great. This is probably because average particle diameter D₁ of the first hydrogen-absorbing alloy is 50 μm or less and hence the particles are relatively small.

Furthermore, the high-temperature life property in sample A9 of a volume percentage of 29% is lower than that in sample A8, and the high-temperature life property in samples B1-B4 of a volume percentage of 30% or more is lower than that in sample A3. This is probably because, at a volume percentage of 30% or more, the crack of the spherical alloy of average particle diameter D₁ of 50 μm or less is more remarkable than the crack of the non-spherical alloy particles.

Furthermore, the low-temperature discharge characteristic and the rate characteristic are remarkably low in samples B1-B4 in which the content of the first hydrogen-absorbing alloy particles is 30 mass % or more. This is probably because, in these samples, the content of the first hydrogen-absorbing alloy is relatively high, hence the activity of the first hydrogen-absorbing alloy is remarkably low, and the increase in reaction resistance during discharge cannot be suppressed.

Next, according to the evaluation results of samples A2, A10-A15, and B5, it is understood that the high-rate discharge rate is high when average particle diameter D₁ of the first hydrogen-absorbing alloy is 18 μm (sample A10) or more and 50 μm (sample A15). While, in sample B5 in which average particle diameter D₁ is 55 μm, the high-rate discharge rate is extremely low. This is probably because the first hydrogen-absorbing alloy particles are apt to be activated due to the existing of average particle diameter D₁ in the above-mentioned range. The high-temperature life property is slightly low in sample A10 in which average particle diameter D₁ is 18 μm. This is probably because this value of average particle diameter D₁ is small and hence this sample is slightly disadvantageous from the viewpoint of the pulverization by the charge/discharge cycle.

Next, according to the evaluation results of samples A2 and A16-A23, it is understood that the high-rate discharge rate is high when average particle diameter D₂ of the second hydrogen-absorbing alloy is 12 μm (sample A16) or more and 60 μm (sample A22). While, in sample A23 in which average particle diameter D₂ is 65 μm, the high-rate discharge rate is slightly low. This is probably because the second hydrogen-absorbing alloy particles are apt to be activated due to the existing of average particle diameter D₂ in the above-mentioned range. The high-temperature life property is slightly low in sample A16 in which average particle diameter D₂ is 12 μm. This is probably because this value of average particle diameter D₂ is small and hence this sample is slightly disadvantageous from the viewpoint of the pulverization by the charge/discharge cycle.

Next, according to the evaluation results of samples A1 and A2, it is understood that the high-rate discharge rate is high when the first hydrogen-absorbing alloy particles have a projecting portion. According to the evaluation results of samples A2 and A24-A27, it is understood that the high-rate discharge rate in samples A2, A25, and A26 in which the height of the projecting portion is 10% or more and 18% or less of the diameter of the core portion is higher than that in sample A1 having no projecting portion and that in sample A24 in which the height of the projecting portion is low. It is also found that surface area S₁ is larger as the projecting portion is higher. In sample A27, however, nitrogen content N₁ exceeds 0.2 wt %. It is considered that the amount of nitrogen product on the surface becomes large to inhibit the electrode reaction, and hence the high-rate discharge rate is low. Therefore, it is expected that, when the height of the projecting portion is made greater than 18% of the diameter of the core portion by a method other than production of the nitrogen products, the high-rate discharge rate may be improved.

Next, according to the evaluation results of samples A2 and A28-A30, it is understood that even when the content of Ni magnetic substance in the first hydrogen-absorbing alloy is less than 3 wt % and when the content of Ni magnetic substance in the second hydrogen-absorbing alloy is 3 wt % or more (sample A30), the high-rate discharge rate is low. According to the evaluation results of samples A2 and A31-A33, it is understood that even when the content of Ni magnetic substance in the second hydrogen-absorbing alloy is less than 3 wt % and when the content of Ni magnetic substance in the first hydrogen-absorbing alloy is 3 wt % or more (sample A33), the high-rate discharge rate is low. Therefore, it is preferable that the content (VSM value) of the magnetic substance in each of the first and second hydrogen-absorbing alloys is larger than 0 wt % and less than 3 wt %.

### INDUSTRIAL APPLICABILITY

The present invention relates to alloy powder for electrodes, a negative electrode for nickel-metal hydride storage batteries using the alloy powder, and a nickel-metal hydride storage battery, and can improve the life property and discharge characteristic. Therefore, this nickel-metal hydride storage battery is expected to be used as an alternative of a dry battery and as a power source for various apparatuses, and can be expected to be used as a power source for a hybrid automobile or the like.

### REFERENCE MARKS IN THE DRAWINGS

1 negative electrode
1C negative electrode core member (core member)
1E negative electrode mixture layer
2 positive electrode
3 separator
4 battery case
6 safety valve
7 seal plate
8 insulating gasket
9 positive electrode lead
10 electrode group
11, 12 particle
11C core portion
11P projecting portion

1. Alloy powder for electrodes, comprising:
particles of a first hydrogen-absorbing alloy, each of the particles having a spherical core portion; and
non-spherical particles of a second hydrogen-absorbing alloy,
wherein an average particle diameter of the first hydrogen-absorbing alloy is more than 0 μm and 50 μm or less, and
a content of the first hydrogen-absorbing alloy is more than 0 vol % and less than 30 vol %.

2. The alloy powder for electrodes according to claim 1,
wherein the average particle diameter of the first hydrogen-absorbing alloy is 20 μm or more and 50 μm or less.

3. The alloy powder for electrodes according to claim 1,
wherein an average particle diameter of the second hydrogen-absorbing alloy is 15 μm or more and 60 μm or less.

4. The alloy powder for electrodes according to claim 1,
wherein a projecting portion is provided on a surface of the core portion of the first hydrogen-absorbing alloy, and
a height of the projecting portion with respect to the surface of the core portion is equal to or more than 10% of a diameter of the core portion.

5. The alloy powder for electrodes according to claim 1,
wherein a specific surface area of the first hydrogen-absorbing alloy is 0.01 g/m² or more and 1.0 g/m² or less.

6. The alloy powder for electrodes according to claim 1,
wherein a composition of the first hydrogen-absorbing alloy contains nitrogen by more than 0 wt % and 0.2 wt % or less.

7. The alloy powder for electrodes according to claim 1,
wherein a composition of each of the first hydrogen-absorbing alloy and the second hydrogen-absorbing alloy contains Ni, and
a content of an Ni magnetic substance in each of the first hydrogen-absorbing alloy and the second hydrogen-absorbing alloy is more than 0 wt % and less than 3 wt %, the content being determined by a vibration-sample magnetic measuring device.

8. The alloy powder for electrodes according to claim 1,
wherein the first hydrogen-absorbing alloy includes particles prepared by an atomizing method.

9. A negative electrode for nickel-metal hydride storage batteries, the negative electrode comprising:
the alloy powder for electrodes according to claim 1; and
a current collector electrically coupled to the alloy powder for electrodes.

10. A nickel-metal hydride storage battery comprising:
a positive electrode;
the negative electrode according to claim 9; and
a separator and an alkaline electrolytic solution both interposed between the positive electrode and the negative electrode.
